(19) United States
(12) Patent Application Publication
(10) Pub. No.: US 2004/0048506 A1
(43) Pub. Date: Mar. 11, 2004

(54) Electrical connector assembly with pull tab

(76) Inventors: Yung Chien Chung, Tu-Chen (TW); Hsien-Chu Lin, Tu-Chen (TW); Chieh Chao Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/302,473

(22) Filed: Nov. 22, 2002

(30) Foreign Application Priority Data
Sep. 9, 2002 (TW) 91214024

(51) Int. Cl. H01R 13/62

(52) U.S. Cl. 439/152

(57) ABSTRACT

An electrical connector assembly (1) has an electrical connector (2), and a pull tab (3) for extracting the electrical connector from a mated connector. The pull tab has a mounting hole (311) assembling the pull tab to the electrical connector, and a cavity (321) for a cable of the electrical connector extending therethrough. The pull tab further has a sidelong slot (322) defined therein and communicating with the cavity.

### CROSS-REFERENCE TO RELATED APPLICATION

This present application is related to a U.S. patent application Ser. No. 10/120,633, invented by David Tso-Chin Ko, entitled “PULL TAB FOR EXTRACTING ELECTRICAL CONNECTOR” filed on Apr. 4, 2002; an patent application entitled “ELECTRICAL CONNECTOR ASSEMBLY WITH EXTRACTION TOOL”, contemporaneously filed and invented by Yong-qian Zhong et al., assigned to the common assignee. Copies of the specifications are hereto attached.

### BACKGROUND OF THE INVENTION

1. Field of the Invention

The present invention generally relates to an electrical connector assembly, and more particularly to an electrical connector assembly having a pull tab providing a robust holding of the connector assembly for separating the connector from a mated connector.

2. Brief Description of the Related Art

The connector becomes smaller and smaller so as to benefit a thin, compact, and robust electrical device, such as Notebook Computer. As a result, it will be very difficult to get hold of it when it is removed from a mated connector. Sometimes the connector is pulled out by its associated cable, which will destroy the electrical connection between the connectors and the cables. Some extraction tools have been invented to solve above-mentioned questions.

U.S. Pat. No. 4,961,256, issued to Faillace on Oct. 9, 1990, discloses an extraction tool inserted between an electrical connector and an electrical device. The extraction tool has a level arm and a pair of object-contacting arms. The extraction tool is useful for separating objects from other devices. However the extraction tool of Faillace patent occupies large outer space which does not meet trend of electronic devices.

JP Pat. Publication No. 2001-035592, issued on Feb. 9, 2001, discloses an L-shaped extraction tab for extracting a connector from a periphery equipment. The L-shaped extraction tab has a cylindrical part mating with the connector, an action part and a knob part extending from a free end of the action part, the action part further defines a recess for a cable of the connector to extend through. The extraction tab may be assembled to the connector after the cable being assembled to the periphery equipment if the recess is big enough, which may cause the cable escaping from the recess of the extraction tab. The extraction tab may be assembled to the connector before the cable being assembled to the periphery equipment if the recess is very small, which may increase the difficulty of assembling the connector to the periphery equipment.

U.S. patent application Ser. No. 10/120,633, assigned to the same assignee as the present invention, discloses a related pull tab for extracting an electrical connector from a mated connector, the pull tab has an engaging portion and a handling portion, the engaging portion has an engaging opening assembled to the electrical connector, and the handling portion defines a retaining aperture at a free end thereof receiving a cable of the electrical connector. However the retaining aperture is defined much big so that the cable may escape therefrom easily. Furthermore, the engaging portion engages with a shell or a cable retaining portion of the electrical connector, so that an outer force may not be transferred properly.

Hence, an improved pull tab is desired to overcome the above-mentioned shortcomings.

### BRIEF SUMMARY OF THE INVENTION

It is an object of this invention to provide an electrical connector assembly with a pull tab facilitating extracting the electrical connector assembly from a peripheral equipment.

An electrical connector assembly has an electrical connector, and a pull tab for extracting the electrical connector from a mated connector. The pull tab has a mounting portion and a handling portion. The mounting portion defines a mounting hole assembling the pull tab to the electrical connector. The handling portion defines a cavity for a cable of the electrical connector extending therethrough and a sidelong slot communicating with the cavity for facilitating assembling of the cable into the cavity of the pull tab.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of an electrical connector assembly with a pull tab of the present invention.

FIG. 2 is a perspective view of the pull tab of FIG. 1.

### DETAILED DESCRIPTION OF THE INVENTION

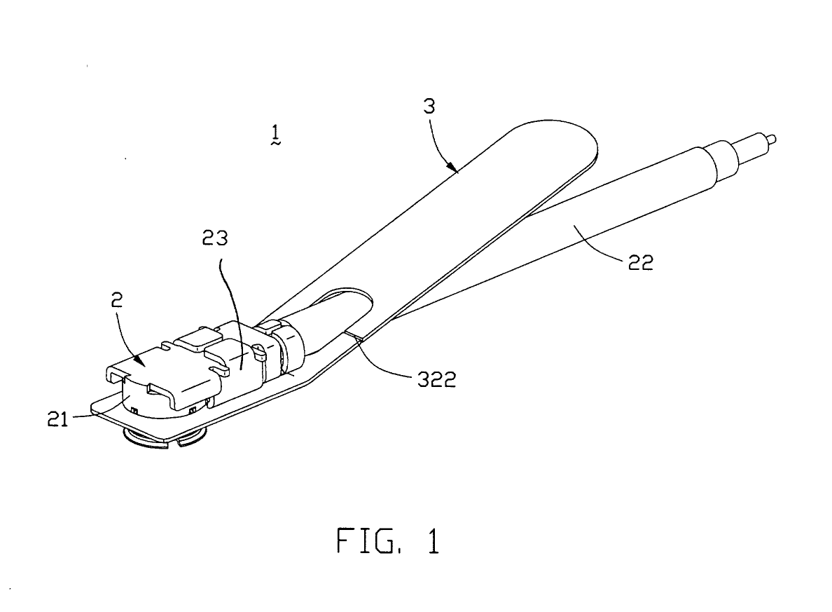

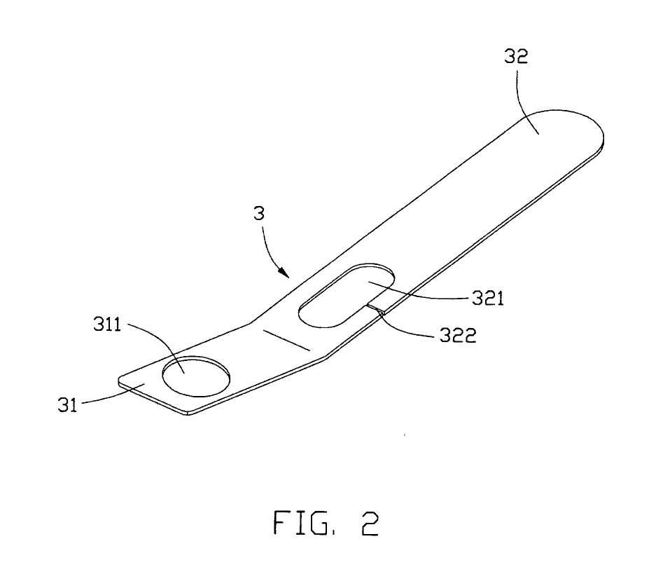

Referring to FIGS. 1 and 2, an electrical connector assembly 1 has an electrical connector 2 and a pull tab 3 for extracting the electrical connector 2 from a mated connector (not shown). The electrical connector 2 has a mating portion 21 with a cylindrical port on the front portion and a horizontal section 23 on a rear portion, and a cable 22 extending rearwardly from the horizontal section 23 of the mating portion 21.

The pull tab 3 has a mounting potion 31 and a handling portion 32 extending from the mounting portion 31. The mounting portion 31 defines a mounting hole 311 adjacent to a free end thereof. The mounting hole 311 has a diameter substantially equal to an exterior diameter of the mating portion 21 of the electrical connector 2. The handling portion 32 defines a cavity 321 adjacent to the mounting portion 31 with a width less than the diameter of the mounting hole 311. The handling portion 32 further defines a slot 322 at a side portion thereof communicating with the cavity 321 thereof.

In assembly, a free end of the cable 22 is soldered to an electrical element (not shown), the mounting hole 311 of the pull tab 3 encircles the mating portion 21 of the electrical connector 2. The cable 22 of the electrical connector 2 is inserted in the cavity 321 of the pull tab 3 by passing through the slot 322 of the pull tab 3.

In use, an outer force is exerted on the handling portion 32, the outer force is transferred to the electrical connector 2 by the engagement of the mating portion 21 and the mounting hole 311. Thus, the electrical connector assembly 1 is extracted from a mated connector.

An advantage of the present invention over the prior art results from the fact that the pull tab 3 of the electrical connector assembly 1 defines a cavity 321 and a slot 322 communicating with the cavity 321, thus the cable 22 of the electrical connector 2 may be assembled into the cavity 321 through the slot 322. As a result, the cavity 321 may be much small, the pull tab 3 may be assembled to the electrical connector 2 after the cable 22 of the electrical connector 2 being soldered to the electrical element, and the cable 22 may not escape from the cavity 321 of the pull tab 3.

It is to be understood, however, that even though numerous, characteristics and advantages of the present invention have been set forth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising
an electrical connector having a mating portion and a cable; and
a pull tab, the pull tab having a mounting hole assembled to the mating portion of the electrical connector, a cavity receiving the cable of the electrical connector, and a sidelong slot communicating with the cavity.

2. The electrical connector claim 1, wherein the sidelong slot is defined in a periphery wall of the pull tab adjacent to the cavity.

3. The electrical connector of claim 1, wherein the pull tab has a mounting portion and a handling portion curved from the mounting portion.

4. The electrical connector of claim 3, wherein the mounting hole is defined in the mounting portion adjacent to a free end of the mounting portion.

5. A pull tab for extracting an electrical connector with a cable from a mated connector, comprising:
a mounting portion defining a mounting hole for assembling the mounting portion to the electrical connector; and
a handling portion defining a cavity for receiving the cable of the electrical connector and a sidelong slot communicating with the cavity; wherein
an outer force is exerted on the handling portion for extracting the electrical connector from the mated connector.

6. An electrical connector assembly comprising:
an electrical connector defining a cylindrical port and a horizontal section located behind the cylindrical port, and a cable rearwardly extending from the horizontal section; and
a pull tab including a horizontal mounting portion and a handle extending rearwardly obliquely from the mounting portion, said mounting portion defining a mounting hole in compliance with the cylindrical port, and said handle defining a through hole with a width similar to a diameter of the cable; wherein
the cylindrical port is received in the mounting hole, the horizontal section is seated upon the mounting portion, and the cable extends through the through hole.

7. The assembly as claimed in claim 6, wherein said handle defines a slit to have the through hole transversely communicate with an exterior.

8. The assembly as claimed in claim 7, wherein said slit does not extend along a lengthwise direction of the handle.

9. The assembly as claimed in claim 7, wherein said through hole is proximate the mounting portion.
